(19) United States
(12) Patent Application Publication
(10) Pub. No.: US 2002/0186502 A1
(43) Pub. Date: Dec. 12, 2002

(54) Motor module with mechanism for z-axis, spindle and hub load for disk drives with removable media

(76) Inventors: Arulmani Ethirajan, Singapore (SG); Lawrence Clayton, Farmington, UT (US)

Correspondence Address: Richard E. Kurtz, WOODCOCK WASHBURN KURTZ, MACKIEWICZ & NORRIS LLP, One Liberty Place - 46th Floor, Philadelphia, PA, 19103, US

(21) Appl. No.: 09/875,219

(22) Filed: Jun. 6, 2001

(51) Int. Cl. G11B 17/02

(52) U.S. Cl. 360/99.12

(57) ABSTRACT

In a disk drive of the type in which a removable cartridge has a storage disk inserted therein, a spindle motor includes a spindle having a hub and a rotor cup. Only the spindle and the rotor cup are translated in the Z-axis into engagement of the hub with the disk as the cartridge is inserted into the drive. A cam and a lever which is rotated as the cartridge is inserted into the drive translate the spindle and the rotor cup in the Z-axis.

This invention relates to data storage disk drives and more particularly to an improved spindle motor loading mechanism.

Removable disk cartridges for storing digital electronic information typically comprise an outer casing or shell that houses a rotatable recording medium, or disk, upon which electronic information can be stored. The cartridge shell often comprises upper and lower halves that are joined together to house the disk. The disk is mounted on a hub that rotates freely within the cartridge. When the cartridge is inserted into a disk drive, a motor-driven spindle in the drive must engage the hub in order to rotate the disk(s) within the cartridge

Standard floppy disk drives typically employ a mechanism that guides the disk cartridge as it is inserted into the drive, so that the hub of the disk is brought downwardly into engagement with a fixed, rotatable spindle. These drives must be of sufficient height to accommodate the vertical movement of the floppy disk. A more preferable solution is to provide a straight insertion path for the cartridge and to move the spindle motor into engagement with the hub of the cartridge.

The popular and commercially successfully Iomega ZIP™ drive provides a straight insertion path for its disk cartridge. Guide rails within the ZIP™ drive guide the cartridge straight into the drive. When the cartridge reaches a certain point during insertion, the front peripheral edge of the cartridge contacts a cartridge receiving stop on a movable platform within the drive. The spindle motor of the disk drive is mounted on the movable platform. Continued insertion of the cartridge into the drive pushes the movable platform backward. As the movable platform moves backward within the drive, the platform raises to bring the spindle motor on the platform into engagement with the hub of the disk cartridge.

The foregoing function has been performed by a moving platform in ZIP™ drives such as shown in U.S. Pat. Nos. 5,617,397, Jones et al. and 5,805,555, Jones et al. In a variation of the ZIP™ suitable for use in Notebook computers, the translation of the spindle motor in the Z-axis is performed by a helical motor assembly as shown in U.S. Pat. No. 5,912,786, Nicklos, et al.

Z-axis actuation of the motor in the 1″ ZIP™ drive is achieved by moving a massive plastic platform along plastic rails, which generates significant friction. Z-axis actuation of the motor in the 0.5″ Notebook ZIP™ is achieved by rotation of a motor ring assembly to which the spindle motor is attached. The entire mass of the motor along with an inner motor ring move along the Z-axis for the Notebook ZIP™ drive with significant friction being generated by the complex motor ring assembly.

Disk drives with removable media such as the ZIP™ drives from Iomega must precisely position the media in the z-axis following cartridge insertion. This is necessary for the head(s) to acquire the correct track of data on the disk. It is important to minimize the drag on the spinning media.

It is an object of the present invention to reduce the mass which must be translated in the vertical or Z-axis, direction, when the spindle motor is loaded into engagement with the hub of the cartridge. It is a further object of the present invention to minimize drag on the spinning media.

### SUMMARY OF THE INVENTION

In accordance with the present invention, the spindle motor has a hub and a rotor cup which are translated into engagement of the hub with the disk as the cartridge is inserted into the drive.

A cam is rotated by a lever which moves as the cartridge is inserted into the drive. The cam translates the spindle and the rotor cup as the lever is moved.

The present invention requires only that the motor spindle and rotor cup assembly move along the Z-axis thus significantly reducing the mass which is actuated relative to ZIP™ and Notebook ZIP™ drives. Movement of the motor spindle and rotor cup assembly is guided by a sleeve bearing, which is rigidly mounted to the drive. Movement of the spindle along the Z-axis in the sleeve bearing will generate significantly less friction than either of the prior motor loading systems schemes.

Tight spindle to sleeve bearing tolerances control the X-Y positioning of the motor hub and spindle more precisely than the prior motor loading schemes. The entire motor loading mechanism may be integrated into a module which includes the motor thus simplifying assembly and reducing complexity and cost.

The foregoing and other objects, features and advantages will be better understood from the following more detailed description and appended claims

### SHORT DESCRIPTION OF THE DRAWINGS

FIG. 1 shows a disk drive of the type in which the motor module of the present invention is an improvement;

FIG. 2 shows an exploded view of the motor and loading mechanism module;

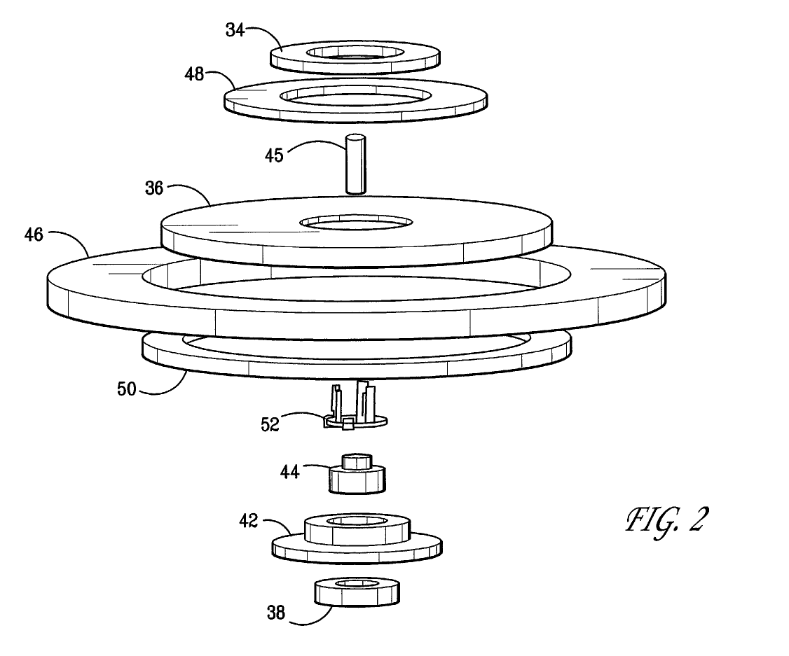

FIG. 3 shows a cross section of the motor loading mechanism of the present invention;

FIG. 4 shows the motor loading cam and hub retainer; and

FIG. 5 depicts the motor load sequence.

### DESCRIPTION OF THE PREFERRED EMBODIMENTS

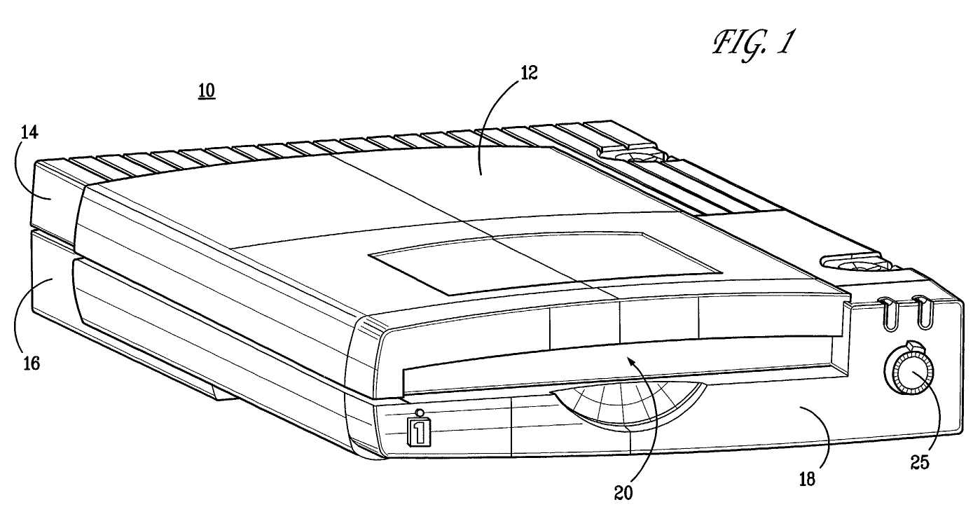

There is shown in FIG. 1 a data storage device, or disk drive 10, in which the present invention is embodied. As shown, the disk drive 10 comprises an outer housing 12 having top and bottom covers 14, 16 and a front panel 18. A disk cartridge can be inserted into the disk drive 10 through a horizontal opening 20 in the front panel 18 of the disk drive 10. The cartridge is engaged by a spindle motor which rotates the hub of the disk. An eject button 22 is also provided on the front panel for automatically ejecting a disk cartridge from the disk drive 10. The disk drive 10 can be employed as a stand-alone unit, or alternatively, can be employed as an internal disk drive of a computer (not shown). The foregoing is more fully described in U.S. Pat. No. 5,617,397 which is incorporated herein by reference.

In accordance with the present invention the spindle motor includes a hub 34 and a rotor cup 36. A cam 38 translates the spindle and the rotor cup 36 into engagement of the hub with the disk as the cartridge is inserted in to the drive. A lever 40 is rotated as the cartridge is inserted into the drive. The cam 38 translates the spindle and the motor cup in the Z-axis as the lever 40 is rotated.

A bearing tower 42, which encloses a sleeve bearing 44 is surrounded by a stator assembly 46 which is rigidly mounted to the drive chassis. The sleeve bearing 44 inside the bearing tower 42 guides the motor spindle 45 along the Z-axis. Attached to the spindle is spindle hub 34, a chucking magnet 48, a rotor cup 36 and a rotor magnet 50 which engages the media hub and rotate freely in the sleeve bearing 44. A hub retainer 52 has clips 52a-52c which capture the rotor cup assembly which supports the spindle along its Z-axis functioning as a journal bearing. The sequence of events during a spindle load is as follows:

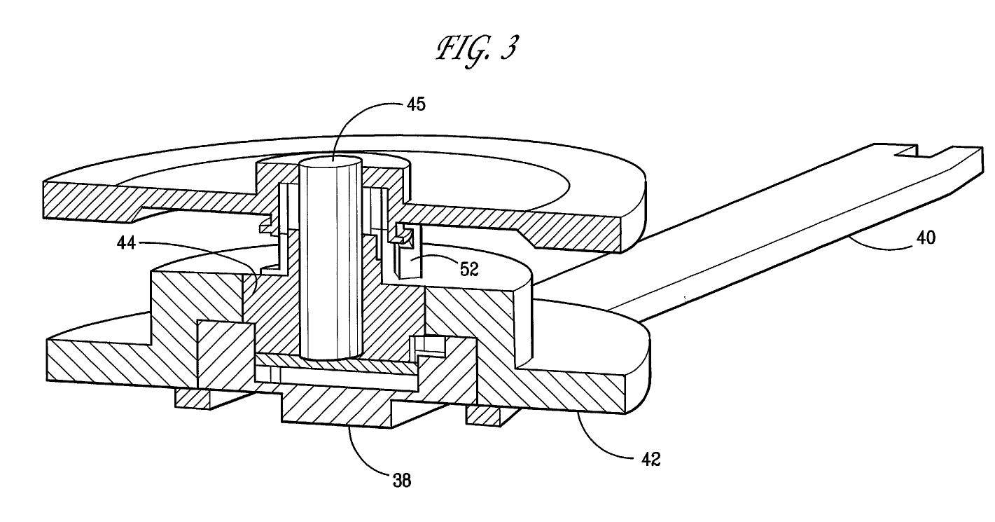

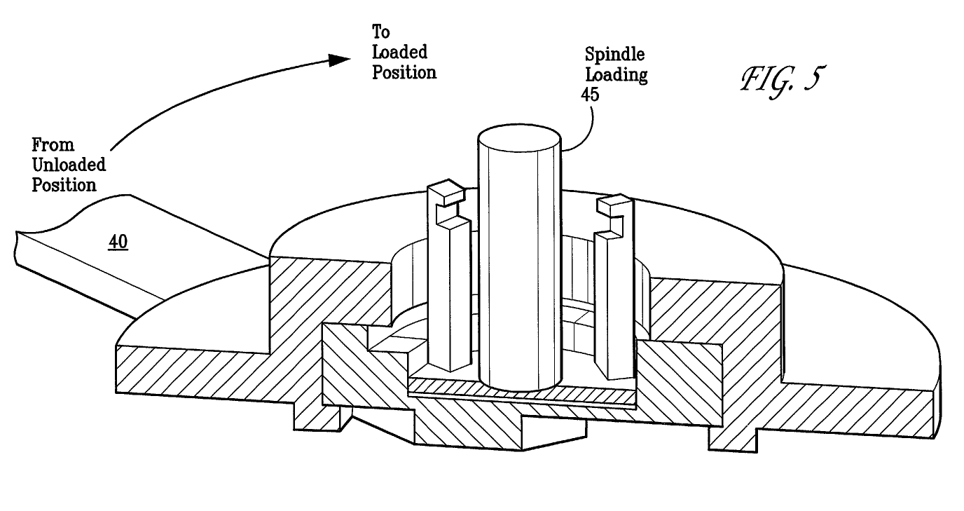

1. During cartridge insertion the cartridge pushes on a linkage which engages the cam lever 40 and rotates the cam 38 as depicted in FIGS. 3-5.

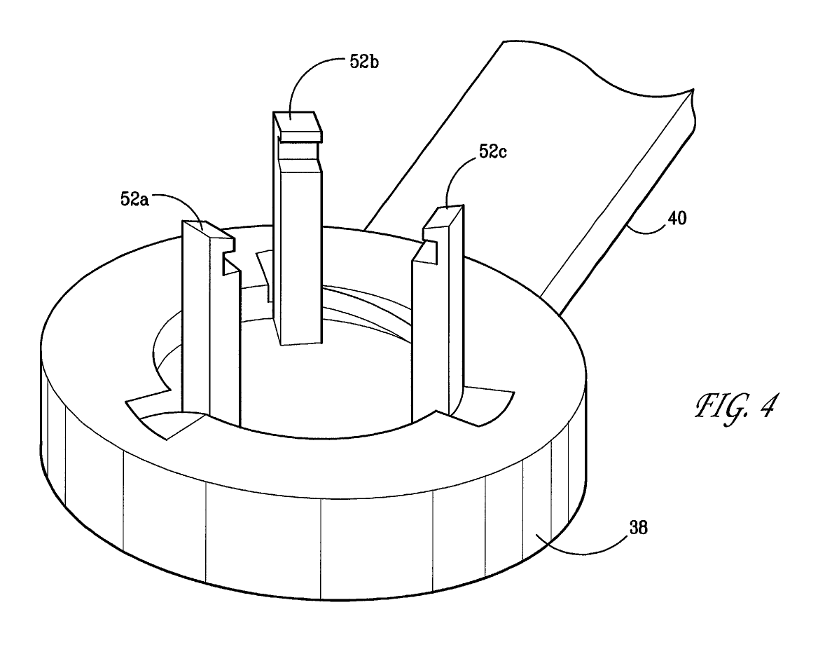

2. Rotating the cam 38 drives the hub retainer 52 up the cam profile depicted in FIG. 4. Slots in the sleeve bearing 44 prevent the hub retainer from rotating forcing it to translate along the Z-axis.

3. As the retainer 52 translates along the Z-axis the spindle 45, which is guided by the sleeve bearing 44, translates toward the media and chucking magnet 48 locks the media hub to the spindle hub 34. Continued translation precisely positions the media for head acquire and drag minimization.

4. Once the media is positioned, the spindle hub 34 and rotor cup 36 assembly, along with the media, are free to rotate in the sleeve bearing 44 supported by the hub retainer 52 which acts as a journal bearing.

5. During unload an external electro-mechanical device drives the linkage rotating the cam lever 40 in the reverse direction lowering the spindle and rotor cup assembly away from the media hub allowing the cartridge to be ejected.

6. With the motor in the unloaded condition, clips 52a-52c on the hub retainer prevent the rotor cup assembly from falling off under non-operational conditions.

While a particular embodiment of the invention has been shown and described various modifications may be made. All such modifications within the true scope of the invention are covered by the appended claims.

What is claimed is:

1. A disk drive of the type in which a removable cartridge having a storage disk therein is inserted into said drive comprising:
a motor including:
a spindle having a hub;
a rotor cup; and
means for translating said spindle and said rotor cup into engagement of said hub with said disk as said cartridge is inserted into said drive.

2. The disk drive recited in claim 1 wherein said means for translating comprises:
a cam;
a lever which is rotated as said cartridge is inserted into said drive, said cam translating said spindle and said rotor cup as said lever is rotated.

3. The disk drive recited in claim 1 further comprising:
a bearing tower guiding said spindle during translation.

4. The disk drive recited in claim 3 further comprising:
a sleeve bearing enclosed by said bearing tower.

5. The disk drive recited in claim 4 further comprising a stator assembly surrounding said bearing tower, said stator assembly being rigidly mounted to said disk drive.

6. The disk drive recited in claim 1 further comprising:
a chucking magnet attached to said hub.

7. The disk drive recited in claim 1 further comprising:
a rotor magnet in said rotor cup.

8. The disk drive recited in claim 1 further comprising:
a hub retainer having clips which capture said rotor cup.
